(19) United States
(12) Patent Application Publication
(10) Pub. No.: US 2024/0201468 A1
(43) Pub. Date: Jun. 20, 2024

(54) LENS DEVICE

(71) Applicant: FUJIFILM Corporation, Tokyo (JP)

(72) Inventors: Satoru NEMOTO, Saitama-shi (JP); Masami OKAMOTO, Saitama-shi (JP)

(73) Assignee: FUJIFILM Corporation, Tokyo (JP)

(21) Appl. No.: 18/530,148

(22) Filed: Dec. 5, 2023

(30) Foreign Application Priority Data
Dec. 15, 2022 (JP) 2022-200481

(51) Int. Cl. G02B 7/02

(52) U.S. Cl. CPC G02B 7/023

(57) ABSTRACT

A lens device includes a holding member that holds a lens, a movement member that moves the holding member in a first direction intersecting an optical axis, a first biasing member that biases the holding member in a second direction intersecting the optical axis, and a second biasing member that biases the holding member in a direction of the optical axis, in which a movement portion of the movement member is provided on the holding member.

### CROSS-REFERENCE TO RELATED APPLICATIONS

This application claims priority under 35 USC 119 from Japanese Patent Application No. 2022-200481 filed on Dec. 15, 2022, the disclosure of which is incorporated by reference herein.

### BACKGROUND OF THE INVENTION

### 1. Field of the Invention

The present disclosed technology relates to a lens device.

### 2. Description of the Related Art

JP2008-292778A discloses a lens device in which a lens is assembled to a lens barrel by pressing the lens in a direction of an optical axis with a lens pressing member against a lens receiving portion provided on a peripheral edge of an opening portion of the lens barrel, and a positional adjustment of the lens is performed by biasing the lens in a direction substantially perpendicular to the optical axis through an adjustment screw screwed with the lens barrel. The lens has one curved main surface pressed against the lens receiving portion of the lens barrel.

JP2017-116729A discloses an eccentricity adjustment structure that includes a tubular member and an optical element incorporated into the tubular member, in which an eccentricity adjustment of the optical element is performed by moving the optical element within the tubular member on a plane orthogonal to a direction of a tube axis. The eccentricity adjustment structure is provided with a fixture pin that is attachably and detachably provided at at least one location of a peripheral surface of the optical element and a pin-fixed hole that is provided in the tubular member and into which a part of the fixture pin is inserted, in which the fixture pin is adhered to the pin-fixed hole.

WO2012/004995A discloses a lens unit comprising first and second lens groups, a first lens barrel, a second lens barrel, and an adjustment mechanism. The first lens group and the second lens group each include at least one lens and are disposed in series on the same optical axis to provide a light condensing function. The first lens barrel holds the first lens group. The second lens barrel holds the second lens group and encompasses at least a part of the first lens barrel. The adjustment mechanism is provided in a region where the second lens barrel encompasses at least a part of the first lens barrel among the first lens barrel and the second lens barrel, and adjusts at least one of a positional relationship in their respective optical axis directions, a tilt of their respective optical axes, or an eccentricity between the first lens barrel and the second lens barrel.

### SUMMARY OF THE INVENTION

One embodiment according to the present disclosed technology provides a lens device that can be miniaturized in a radial direction.

According to a first aspect of the present disclosed technology, there is provided a lens device comprising: a holding member that holds a lens; a movement member that moves the holding member in a first direction intersecting an optical axis; a first biasing member that biases the holding member in a second direction intersecting the optical axis; and a second biasing member that biases the holding member at least in a direction of the optical axis, in which a movement portion of the movement member is provided on the holding member.

According to a second aspect of the present disclosed technology, in the lens device according to the first aspect, the movement portion may be provided on an inner side of an outer contour of the holding member.

According to a third aspect of the present disclosed technology, in the lens device according to the first aspect, the movement member may have a screw and a nut, and the movement portion may include the nut.

According to a fourth aspect of the present disclosed technology, in the lens device according to the third aspect, a fixing member may further be provided, the screw may be rotatably fixed to the fixing member, and the nut may be held by the holding member.

According to a fifth aspect of the present disclosed technology, in the lens device according to the first aspect, a restricting member that restricts a position of the holding member in the direction of the optical axis may further be provided.

According to a sixth aspect of the present disclosed technology, in the lens device according to the fifth aspect, a plurality of the restricting members may be provided, and the plurality of restricting members may be arranged in a direction around the optical axis.

According to a seventh aspect of the present disclosed technology, in the lens device according to the fifth aspect, the second biasing member may be disposed at a position corresponding to the restricting member.

According to an eighth aspect of the present disclosed technology, in the lens device according to the fifth aspect, a fixing member may further be provided, and the restricting member may be loosely inserted into the fixing member.

According to a ninth aspect of the present disclosed technology, in the lens device according to the eighth aspect, a loose insertion portion of the restricting member may be a metal member.

According to a tenth aspect of the present disclosed technology, in the lens device according to the ninth aspect, the metal member may be a roller.

According to an eleventh aspect of the present disclosed technology, in the lens device according to the first aspect, the movement member may include a first movement member and a second movement member that moves the holding member in a direction different from a movement direction by the first movement member.

According to a twelfth aspect of the present disclosed technology, in the lens device according to the eleventh aspect, the first biasing member may be disposed within a range of an angle formed by the first movement member and the second movement member, which is less than 180 degrees, as viewed from the direction of the optical axis.

According to a thirteenth aspect of the present disclosed technology, in the lens device according to the twelfth aspect, the first biasing member may be disposed on a bisector line of the angle as viewed from the direction of the optical axis.

According to a fourteenth aspect of the present disclosed technology, in the lens device according to the twelfth aspect, an angle formed by the first movement member and the first biasing member as viewed from the direction of the optical axis may be 30 degrees to 60 degrees.

According to a fifteenth aspect of the present disclosed technology, in the lens device according to the twelfth aspect, the angle may be a right angle.

According to a sixteenth aspect of the present disclosed technology, in the lens device according to the eleventh aspect, a fixing member, and a restricting portion that restricts a position of the holding member in a direction around the optical axis with respect to the fixing member may further be provided, and the restricting portion may be provided on an opposite side of the optical axis from the first movement member.

According to a seventeenth aspect of the present disclosed technology, in the lens device according to the sixteenth aspect, the restricting portion may be provided along a line connecting the first movement member and the optical axis as viewed from the direction of the optical axis.

According to an eighteenth aspect of the present disclosed technology, in the lens device according to the first aspect, a fixing member, and a restricting portion that restricts a position of the holding member in a direction around the optical axis with respect to the fixing member may further be provided.

According to a nineteenth aspect of the present disclosed technology, in the lens device according to the eighteenth aspect, the restricting portion may have an engagement portion formed on the fixing member and an engagement target portion formed on the holding member and engaged with the engagement portion.

According to a twentieth aspect of the present disclosed technology, in the lens device according to the nineteenth aspect, the engagement portion may have a first protruding portion, and the engagement target portion may have a second protruding portion that is in contact with the first protruding portion.

According to a twenty-first aspect of the present disclosed technology, in the lens device according to the twentieth aspect, the second protruding portion may extend in a direction intersecting a direction in which the first protruding portion extends.

### BRIEF DESCRIPTION OF THE DRAWINGS

FIG. 1 is a perspective view showing an example of an imaging apparatus provided with a lens device according to an embodiment.

FIG. 2 is a cross-sectional view showing an example of the lens device according to the embodiment.

FIG. 3 is an enlarged view of an F3 part of FIG. 2.

FIG. 4 is an enlarged view of an F4 part of FIG. 2.

FIG. 5 is an enlarged view of an F5 part of FIG. 2.

FIG. 6 is an enlarged view of an F6 part of FIG. 2.

FIG. 7 is a cross-sectional view taken along line F7-F7 of FIG. 2.

FIG. 8 is an enlarged view of an F8 part of FIG. 7.

FIG. 9 is a cross-sectional view taken along line F9-F9 of FIG. 2.

FIG. 10 is an enlarged view of an F10 part of FIG. 9.

FIG. 11 is a perspective view showing an example of a restricting portion.

FIG. 12 is a cross-sectional view showing a lens device according to a comparative example.

FIG. 13 is an enlarged view of an F13 part of FIG. 12.

### DESCRIPTION OF THE PREFERRED EMBODIMENTS

Hereinafter, one embodiment of the present disclosure will be described with reference to the drawings.

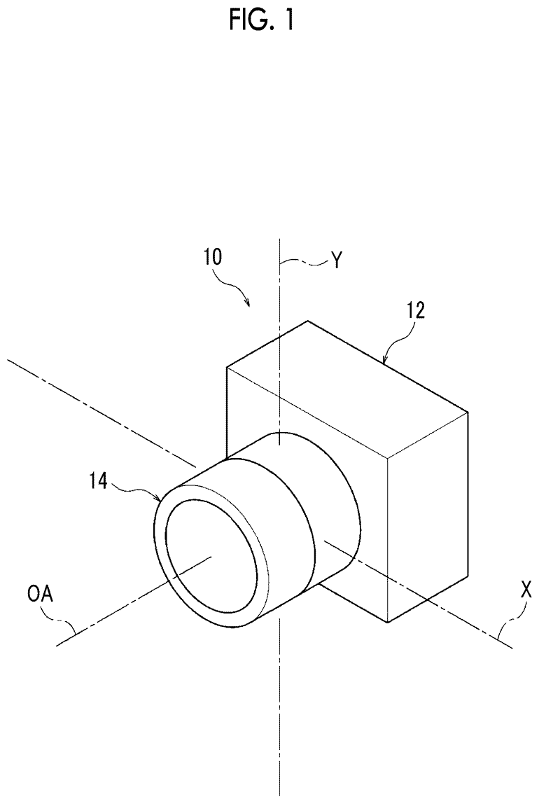

FIG. 1 shows a perspective view of an imaging apparatus 10 comprising a lens device 14 according to the present embodiment. As shown in FIG. 1, the imaging apparatus 10 comprises an imaging apparatus main body 12 and the lens device 14. The imaging apparatus 10 is, as an example, a mirrorless camera. The imaging apparatus 10 may be various cameras other than the mirrorless camera. An image sensor or the like (not shown) is provided inside the imaging apparatus main body 12. The lens device 14 is a device for forming an image of light on a light-receiving surface of the image sensor and is attached to a front surface of the imaging apparatus main body 12.

An X axis, a Y axis, and an optical axis OA of the lens device 14 are axes orthogonal to each other. The X axis is an axis parallel to a yaw axis of the imaging apparatus 10 when viewed from a direction of the optical axis OA, and the Y axis is an axis parallel to a pitch axis of the imaging apparatus 10 when viewed from the direction of the optical axis OA. In the present specification, “being orthogonal” refers not only to “being completely orthogonal” but also to “being orthogonal with a meaning including an error generally acceptable in the technical field to which the present disclosed technology belongs to an extent that is not inconsistent with the gist of the present disclosed technology”. Here, “being parallel” refers not only to “being completely parallel” but also “being parallel with a meaning including an error generally acceptable in the technical field to which the present disclosed technology belongs to an extent that is not inconsistent with the gist of the present disclosed technology”.

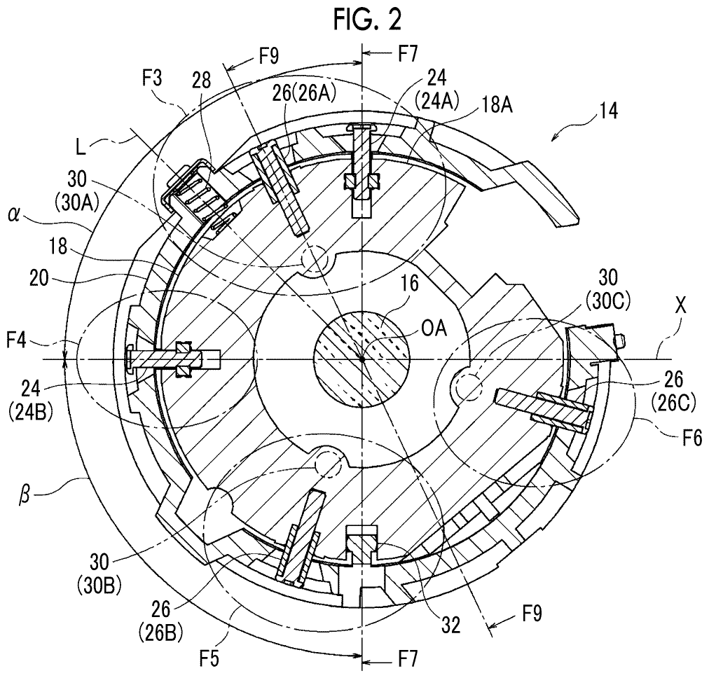

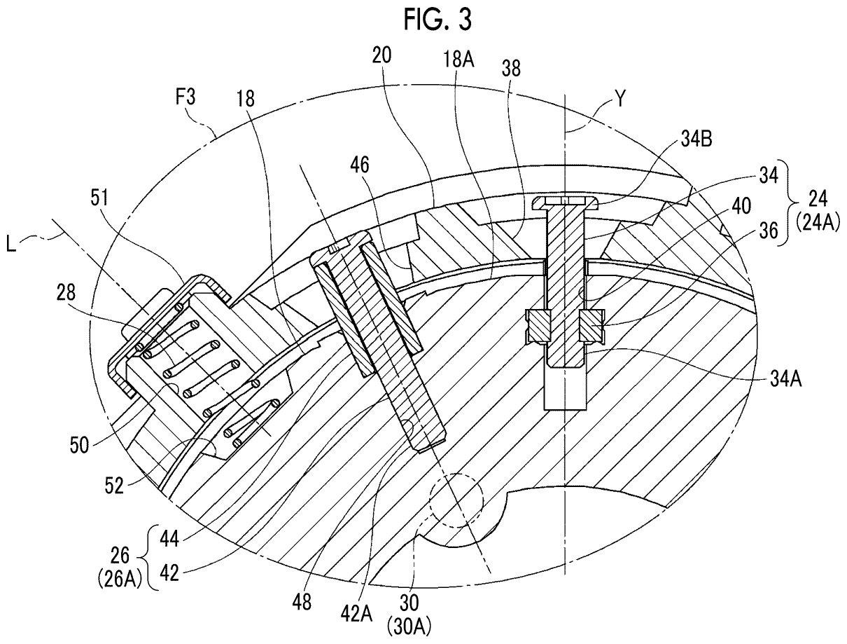

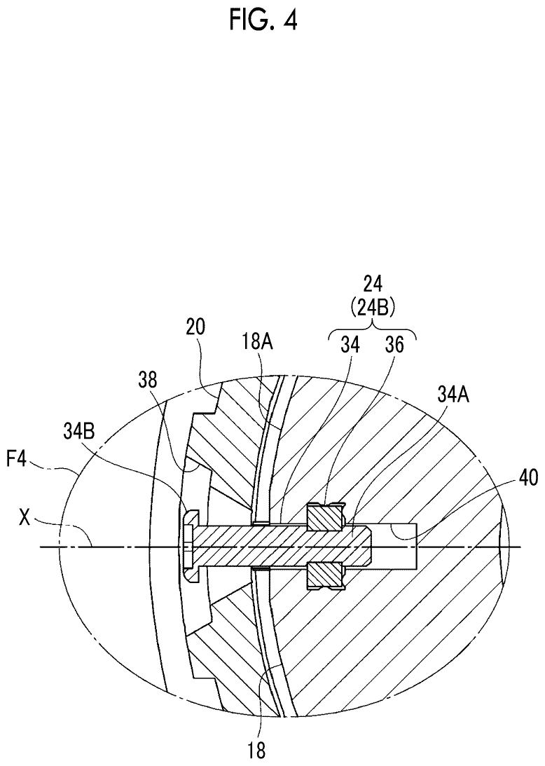

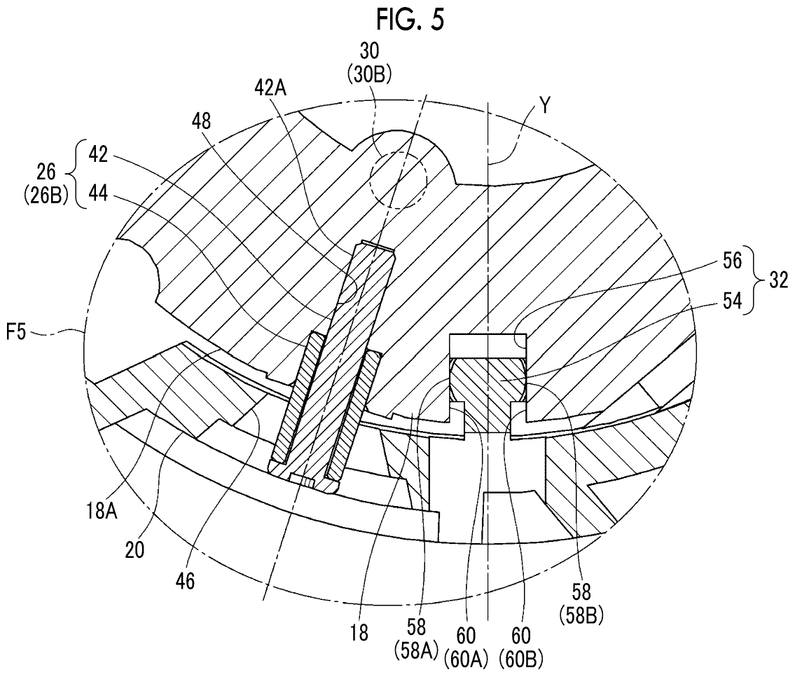

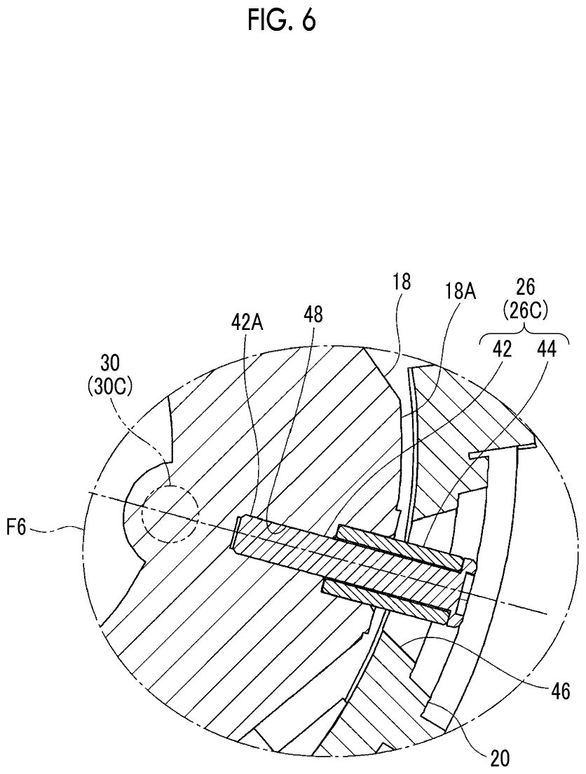

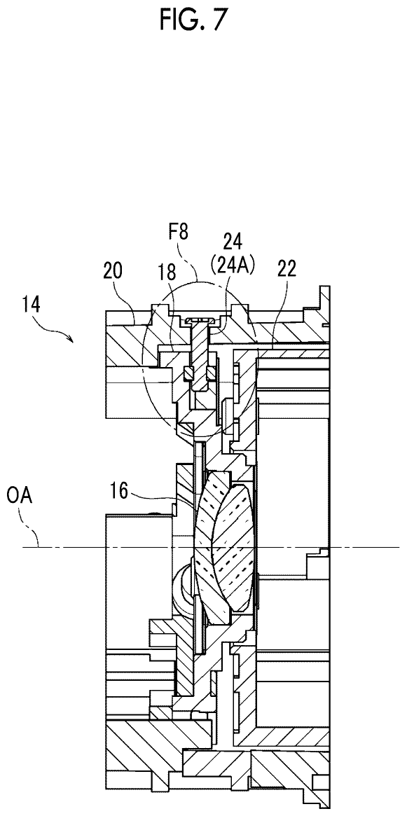

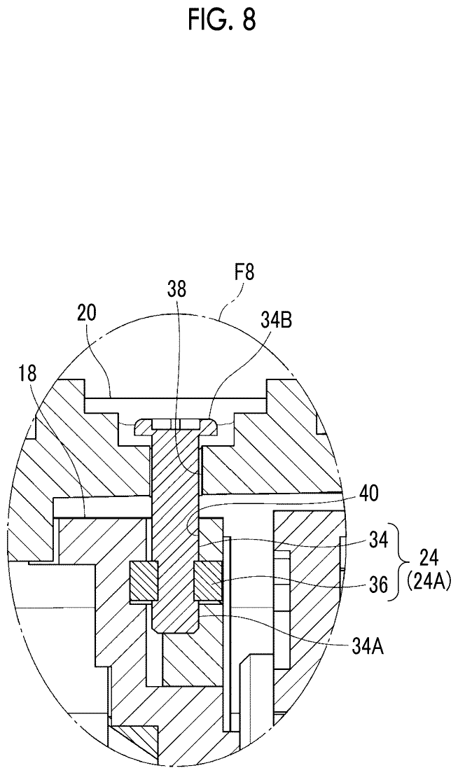

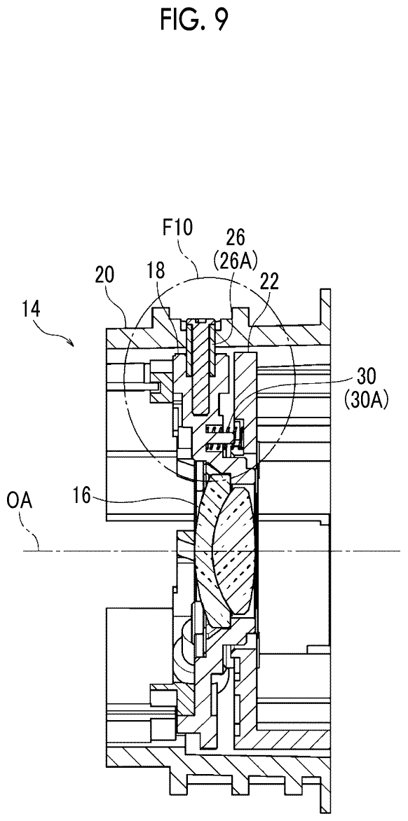

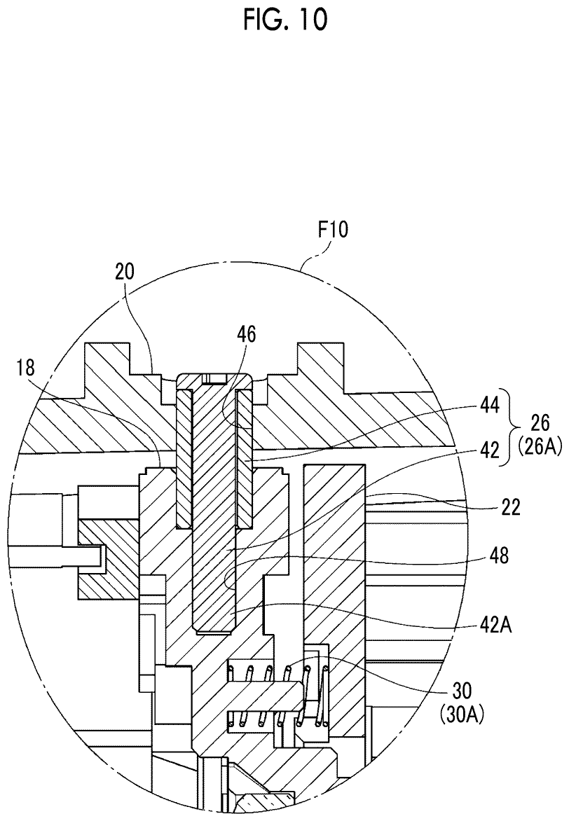

FIG. 2 shows a cross-sectional view of the lens device 14, and FIGS. 3 to 6 show enlarged views of an F3 part, an F4 part, an F5 part, and an F6 part of FIG. 2, respectively. Additionally, FIG. 7 shows a cross-section of the lens device 14 taken along line F7-F7 of FIG. 2, and FIG. 8 shows an enlarged view of an F8 part of FIG. 7. Further, FIG. 9 shows a cross-section of the lens device 14 taken along line F9-F9 of FIG. 2, and FIG. 10 shows an enlarged view of an F10 part of FIG. 9.

As shown in FIGS. 2 to 10, the lens device 14 comprises a lens 16, a holding member 18, a fixing member 20, and a support member 22.

The lens 16 is, as an example, a focus lens within a single-focal-length lens or a zoom lens. The lens 16 may be a lens other than the focus lens. The lens 16 is disposed on the optical axis OA of the lens device 14.

The holding member 18 is a holding frame that holds the lens 16. Specifically, the holding member 18 is formed in an annular shape around the optical axis OA. The lens 16 is disposed at a center portion of the holding member 18, and the lens 16 is held by the holding member 18.

The fixing member 20 is a fixing tube for fixing the holding member 18. Specifically, the fixing member 20 is formed in a tubular shape around the optical axis OA. The holding member 18 and the support member 22 are disposed inside the fixing member 20. The support member 22 is disposed on an image formation side with respect to the holding member 18. The holding member 18 and the support member 22 face each other in the direction of the optical axis OA.

In addition, the lens device 14 comprises a plurality of movement members 24, a plurality of restricting members 26, a first biasing member 28, a plurality of second biasing members 30, and a restricting portion 32.

The number of movement members 24 is, as an example, two. The number of movement members 24 may be one or three or more. Hereinafter, as an example, a case where the number of the plurality of movement members 24 is two will be described as a premise.

A movement member 24A of the two movement members 24 is disposed on the Y axis when viewed from the direction of the optical axis OA, and a movement member 24B of the two movement members 24 is disposed on the X axis when viewed from the direction of the optical axis OA. An angle α formed by the movement member 24A and the movement member 24B as viewed from the direction of the optical axis OA is a right angle. In the present specification, “right angle” refers not only to a perfect right angle but also to a right angle with a meaning including an error generally acceptable in the technical field to which the present disclosed technology belongs to an extent that is not inconsistent with the gist of the present disclosed technology.

The angle α (that is, an angle of less than 180 degrees) formed by the movement member 24A and the movement member 24B is defined by, for example, an angle formed by an axial direction of the movement member 24A and an axial direction of the movement member 24B. The axial direction of the movement member 24A is, as an example, a direction of the Y axis, and the axial direction of the movement member 24B is, as an example, a direction of the X axis. The movement member 24A is an example of a “first movement member” according to the present disclosed technology, and the movement member 24B is an example of a “second movement member” according to the present disclosed technology.

Each movement member 24 is a member that moves the holding member 18 in a direction intersecting the optical axis OA with respect to the fixing member 20. Specifically, each movement member 24 has a screw 34 and a nut 36. In the fixing member 20, a hole 38 that penetrates the fixing member 20 in a radial direction is formed. A shaft portion 34A of the screw 34 is inserted into the hole 38 from the outside of the fixing member 20, and a head portion 34B of the screw 34 is locked to a peripheral edge portion of the opening of the hole 38. In the holding member 18, a hole 40 is formed at a position corresponding to the hole 38, and the shaft portion 34A of the screw 34 inserted into the hole 38 is also inserted into the hole 40.

The nut 36 is disposed coaxially with the hole 40 and is held by the holding member 18. The shaft portion 34A of the screw 34 is screwed with the nut 36. The head portion 34B is locked to the peripheral edge portion of the opening of the hole 38, and the shaft portion 34A is screwed with the nut 36, whereby the screw 34 is rotatably fixed to the fixing member 20.

Each nut 36 is provided on the holding member 18 by being held by the holding member 18. Specifically, each nut 36 is provided on an inner side of an outer contour 18A (that is, an outer edge) of the holding member 18. Each nut 36 is an example of a “movement portion” according to the present disclosed technology.

A screw hole may be formed in the hole 40 instead of the nut 36. In this case, the screw hole is an example of the “movement portion” according to the present disclosed technology.

The movement member 24A is a member that moves the holding member 18 in the direction of the Y axis (that is, an adjustment member that adjusts the position of the holding member 18 in the direction of the Y axis). Specifically, in a case where the screw 34 of the movement member 24A is rotated in a direction in which the screw 34 is tightened with respect to the nut 36, the holding member 18 is moved together with the nut 36 toward a movement member 24A side with respect to the fixing member 20. On the other hand, in a case where the screw 34 of the movement member 24A is rotated in a direction in which the screw 34 is loosened with respect to the nut 36, the holding member 18 moves together with the nut 36 toward a side opposite to the movement member 24A with respect to the fixing member 20. The direction of the Y axis is an example of a “first direction” according to the present disclosed technology.

Similarly, the movement member 24B is a member that moves the holding member 18 in the direction of the X axis (that is, an adjustment member that adjusts the position of the holding member 18 in the direction of the X axis). Specifically, in a case where the screw 34 of the movement member 24B is rotated in a direction in which the screw 34 is tightened with respect to the nut 36, the holding member 18 is moved together with the nut 36 toward a movement member 24B side with respect to the fixing member 20. On the other hand, in a case where the screw 34 of the movement member 24B is rotated in a direction in which the screw 34 is loosened with respect to the nut 36, the holding member 18 moves together with the nut 36 toward a side opposite to the movement member 24B with respect to the fixing member 20. The direction of the X axis is an example of the “first direction” according to the present disclosed technology.

As described above, the movement direction of the holding member 18 by the movement member 24A is set to a direction different from the movement direction of the holding member 18 by the movement member 24B. As an example, the movement direction of the holding member 18 by the movement member 24A and the movement direction of the holding member 18 by the movement member 24B are set to directions orthogonal to each other. By setting the movement direction of the holding member 18 by the movement member 24A to a direction different from the movement direction of the holding member 18 by the movement member 24B, it is possible to improve the degree of freedom in a case where the position of the holding member 18 is adjusted, in comparison with a configuration in which the movement direction of the holding member 18 is one direction.

The movement direction of the holding member 18 by the movement member 24A and the movement direction of the holding member 18 by the movement member 24B are set to directions orthogonal to each other but may be set to directions intersecting each other, other than orthogonal directions. In addition, the movement direction of the holding member 18 by the movement member 24A is set to a direction orthogonal to the optical axis OA but may be set to a direction intersecting the optical axis OA, other than the orthogonal direction. Similarly, the movement direction of the holding member 18 by the movement member 24B is set to a direction orthogonal to the optical axis OA but may be set to a direction intersecting the optical axis OA, other than the orthogonal direction.

The number of restricting members 26 is, as an example, three. The number of restricting members 26 may be one, two, or four or more. Hereinafter, as an example, a case where the number of restricting members 26 is three will be described as a premise.

The three restricting members 26 are arranged at equal intervals in a direction around the optical axis OA. In the present specification, “equal interval” refers not only to a perfect equal interval but also to an equal interval with a meaning including an error generally acceptable in the technical field to which the present disclosed technology belongs to an extent that is not inconsistent with the gist of the present disclosed technology.

A restricting member 26A of the three restricting members 26 is disposed within a range of the angle α formed by the movement member 24A and the movement member 24B as viewed from the direction of the optical axis OA. The restricting member 26A is disposed on the movement member 24A side between the movement member 24A and the movement member 24B. In addition, the restricting member 26A is disposed between the first biasing member 28, which will be described below, and the movement member 24A as viewed from the direction of the optical axis OA.

A restricting member 26B of the three restricting members 26 is disposed within a range of an angle β (that is, an angle of less than 180 degrees) formed by the movement member 24B and the restricting portion 32, which will be described below, as viewed from the direction of the optical axis OA. The restricting member 26B is disposed on a restricting portion 32 side between the movement member 24B and the restricting portion 32. The restricting member 26C of the three restricting members 26 is disposed on an opposite side of the optical axis OA from the first biasing member 28 and the movement member 24B.

Each restricting member 26 is a member that restricts the position of the holding member 18 in the direction of the optical axis OA with respect to the fixing member 20. Specifically, each restricting member 26 has a screw 42 and a roller 44. A hole 46 that penetrates the fixing member 20 in the radial direction is formed in the fixing member 20, and a screw hole 48 is formed in the holding member 18 at a position corresponding to the hole 46. The screw 42 is inserted into the hole 46 from the outside of the fixing member 20, and a shaft portion 42A of the screw 42 is screwed into the screw hole 48. The screw 42 is held by the holding member 18 by screwing the shaft portion 42A into the screw hole 48.

The restricting member 26 is loosely inserted into the fixing member 20. Specifically, the roller 44 of the restricting member 26 is loosely inserted into the hole 46 formed in the fixing member 20. That is, an outer diameter of the roller 44 is set to a dimension smaller than an inner diameter of the hole 46, and a gap is provided between an outer peripheral surface of the roller 44 and an inner peripheral surface of the hole 46. The roller 44 is, as an example, a metal member. The roller 44 is an example of a “loose insertion portion”, a “metal member”, and a “shaft member” according to the present disclosed technology. A non-rotatable shaft member may be used instead of the rotatable roller 44.

In a state in which the holding member 18 is biased in the direction of the optical axis OA by the plurality of second biasing members 30, which will be described below, the outer peripheral surface of the roller 44 is in contact with the inner peripheral surface of the hole 46 on a side where the holding member 18 is biased, whereby the position of the holding member 18 is restricted in the direction of the optical axis OA.

The number of first biasing members 28 is, as an example, one. The number of first biasing members 28 may be two or more. Hereinafter, as an example, a case where the number of first biasing members 28 is one will be described as a premise.

The first biasing member 28 is disposed within the range of the angle α formed by the movement member 24A and the movement member 24B as viewed from the direction of the optical axis OA. The first biasing member 28 is disposed on a bisector line L of the angle α formed by the movement member 24A and the movement member 24B as viewed from the direction of the optical axis OA. In the present specification, “bisector” refers not only to a perfect bisector but also to a bisector with a meaning including an error generally acceptable in the technical field to which the present disclosed technology belongs to an extent that is not inconsistent with the gist of the present disclosed technology.

The first biasing member 28 may be disposed at a position shifted from the bisector line L of the angle α. For example, the first biasing member 28 may be disposed at a position where an angle formed by the movement member 24A and the first biasing member 28 as viewed from the direction of the optical axis OA is 30 degrees to 60 degrees.

The first biasing member 28 is a member that biases the holding member 18 in the direction intersecting the optical axis OA with respect to the fixing member 20. Specifically, the first biasing member 28 is, as an example, a coil spring. The first biasing member 28 may be various springs other than the coil spring or may be an elastic member other than the spring.

The first biasing member 28 is disposed with a direction intersecting the optical axis OA as the axial direction. A recessed portion 50 that is open to a holding member 18 side is formed in the fixing member 20, and a recessed portion 52 that is open to a fixing member 20 side is formed in the holding member 18. The recessed portion 50 is formed at a position corresponding to the recessed portion 52. A bottom of the recessed portion 50 is formed by a lid member 51. The first biasing member 28 is accommodated in a compressed state between the bottom of the recessed portion 50 and a bottom of the recessed portion 52. The holding member 18 is biased toward an optical axis OA side by the first biasing member 28.

Since the holding member 18 is biased by the first biasing member 28, the play of the holding member 18 in the movement direction by each movement member 24 is suppressed. A biasing direction by the first biasing member 28 is set to, as an example, a direction orthogonal to the optical axis OA. The biasing direction of the first biasing member 28 is an example of a “second direction” according to the present disclosed technology.

The biasing direction by the first biasing member 28 is set to the direction orthogonal to the optical axis OA but may be set to the direction intersecting the optical axis OA, other than the orthogonal direction.

The number of second biasing members 30 is, as an example, three. The number of second biasing members 30 may be one, two, or four or more. Hereinafter, as an example, a case where the number of second biasing members 30 is three will be described as a premise.

Each second biasing member 30 is disposed at a position corresponding to each restricting member 26. Specifically, a second biasing member 30A of the three second biasing members 30 is disposed at a position corresponding to the restricting member 26A, a second biasing member 30B of the three second biasing members 30 is disposed at a position corresponding to the restricting member 26B, and a second biasing member 30C of the three second biasing members 30 is disposed at a position corresponding to the restricting member 26C.

Each second biasing member 30 is disposed on the optical axis OA side with respect to the restricting member 26. In addition, each second biasing member 30 is disposed on a central axis of the restricting member 26.

Each second biasing member 30 is a member that biases the holding member 18 in the direction of the optical axis OA with respect to the support member 22. Specifically, the second biasing member 30 is, as an example, a coil spring. The second biasing member 30 may be various springs other than the coil spring or may be an elastic member other than the spring. In addition, each second biasing member 30 may have any configuration as long as it can bias the holding member 18 at least in the direction of the optical axis OA with respect to the support member 22. Further, each second biasing member 30 may be disposed not only in an orientation with the direction of the optical axis OA as the axial direction but also in an orientation in which a component force of the biasing force acts at least in the direction of the optical axis OA on the holding member 18.

Each second biasing member 30 is accommodated in a compressed state between the support member 22 and the holding member 18 in the direction of the optical axis OA. The holding member 18 is biased in the direction of the optical axis OA (specifically, toward an object side) by the second biasing member 30. Since the roller 44 is loosely inserted into the hole 46, the play in the direction of the optical axis OA occurs in the holding member 18. However, the holding member 18 is biased by each second biasing member 30, so that the play of the holding member 18 in the direction of the optical axis OA is suppressed.

Here, as described above, each second biasing member 30 is disposed at a position corresponding to each restricting member 26. Therefore, for example, it is possible to effectively suppress the play of the holding member 18 in the direction of the optical axis OA in comparison with a case where each second biasing member 30 is disposed without corresponding to each restricting member 26.

Each second biasing member 30 may be accommodated in a compressed state between a member (not shown), which is disposed on an opposite side of the holding member 18 from the support member 22, and the holding member 18, whereby the holding member 18 may be biased in the direction of the optical axis OA (specifically, toward the image formation side).

The restricting portion 32 is provided on an opposite side of the optical axis OA from the movement member 24A. Specifically, the restricting portion 32 is disposed along a line connecting the center of the movement member 24A and the optical axis OA as viewed from the direction of the optical axis OA (that is, on an extension line of the line connecting the center of the movement member 24A and the optical axis OA and on the Y axis). The restricting portion 32 is a structural portion that restricts the position of the holding member 18 in the direction around the optical axis OA with respect to the fixing member 20. Specifically, the restricting portion 32 has an engagement portion 54 formed in the fixing member 20 and an engagement target portion 56 formed in the holding member 18.

The engagement portion 54 is a protruding portion that protrudes from the fixing member 20 toward the holding member 18 side, and the engagement target portion 56 is a recessed portion that is open to the fixing member 20 side. The engagement portion 54 is inserted into the engagement target portion 56 and is engaged with the engagement target portion 56. The engagement portion 54 is engaged with the engagement target portion 56, whereby the position of the holding member 18 is restricted in the direction around the optical axis OA with respect to the fixing member 20. The engagement portion 54 may be a recessed portion, and the engagement target portion 56 may be a protruding portion.

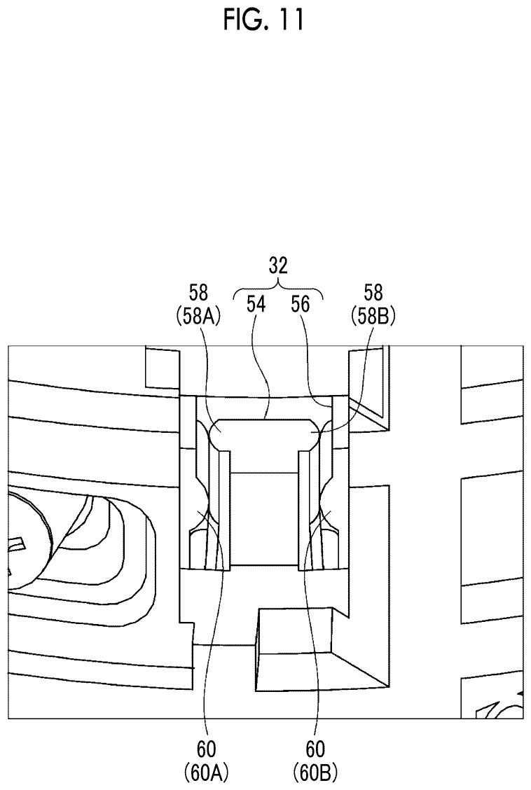

FIG. 11 shows a perspective view of the restricting portion 32. As shown in FIG. 11, the engagement portion 54 has a pair of first protruding portions 58, and the engagement target portion 56 has a pair of second protruding portions 60. The pair of first protruding portions 58 are formed on both side surfaces of the engagement portion 54 formed by the protruding portion. A first protruding portion 58A of the pair of first protruding portions 58 protrudes toward one side in the direction of the X axis, and a first protruding portion 58B of the pair of first protruding portions 58 protrudes toward the other side in the direction of the X axis. The first protruding portion 58A and the first protruding portion 58B have a symmetrical shape in the direction of the X axis.

The pair of second protruding portions 60 are formed on both side surfaces of the engagement target portion 56 formed by the recessed portion. A second protruding portion 60A of the pair of second protruding portions 60 faces the first protruding portion 58A and protrudes toward a first protruding portion 58A side. A second protruding portion 60B of the pair of second protruding portions 60 faces the first protruding portion 58B and protrudes toward a first protruding portion 58B side. The second protruding portion 60A and the second protruding portion 60B have a symmetrical shape in the direction of the X axis.

Each of the first protruding portion 58A and the second protruding portion 60A is formed as a raised ridge. The first protruding portion 58A and the second protruding portion 60A extend in directions intersecting each other. Specifically, the first protruding portion 58A extends in the direction of the optical axis OA, and the second protruding portion 60A extends in the direction of the Y axis. Similarly, the first protruding portion 58B and the second protruding portion 60B extend in directions intersecting each other. Specifically, the first protruding portion 58B extends in the direction of the optical axis OA, and the second protruding portion 60B extends in the direction of the Y axis. A tip part of each first protruding portion 58 in a protruding direction is formed to have a convexly curved cross-sectional shape as viewed from the direction of the optical axis OA. A tip part of each second protruding portion 60 in the protruding direction is formed to have a convexly curved cross-sectional shape as viewed from the direction of the Y axis.

The first protruding portion 58A and the second protruding portion 60A extend in directions orthogonal to each other but may extend in directions intersecting each other, other than orthogonal directions. Similarly, the first protruding portion 58B and the second protruding portion 60B extend in directions orthogonal to each other but may extend in directions intersecting each other, other than orthogonal directions.

The first protruding portion 58A is in contact with the second protruding portion 60A, and the first protruding portion 58B is in contact with the second protruding portion 60B. The first protruding portion 58A is in contact with the second protruding portion 60A, whereby the position of the holding member 18 to the one side in the direction around the optical axis OA is restricted. Similarly, the first protruding portion 58B is in contact with the second protruding portion 60B, whereby the position of the holding member 18 on the other side in the direction around the optical axis OA is restricted.

As described above, the second protruding portion 60 extends in a direction orthogonal to a direction in which the first protruding portion 58 extends. Therefore, for example, even in a case where a position of the second protruding portion 60 with respect to the first protruding portion 58 is shifted in the direction of the optical axis OA and/or the direction of the Y axis due to a dimensional error or the like, the point-contact state between the first protruding portion 58 and the second protruding portion 60 can be maintained.

Next, effects of the lens device 14 according to the present embodiment will be described.

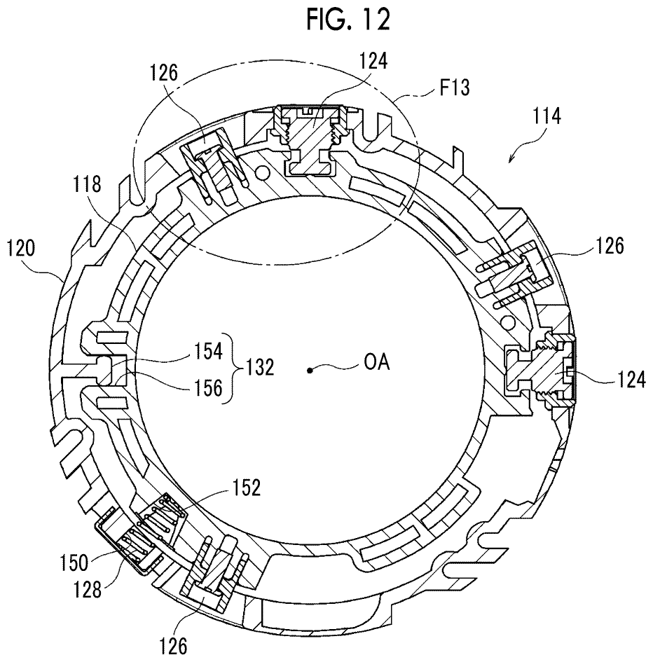

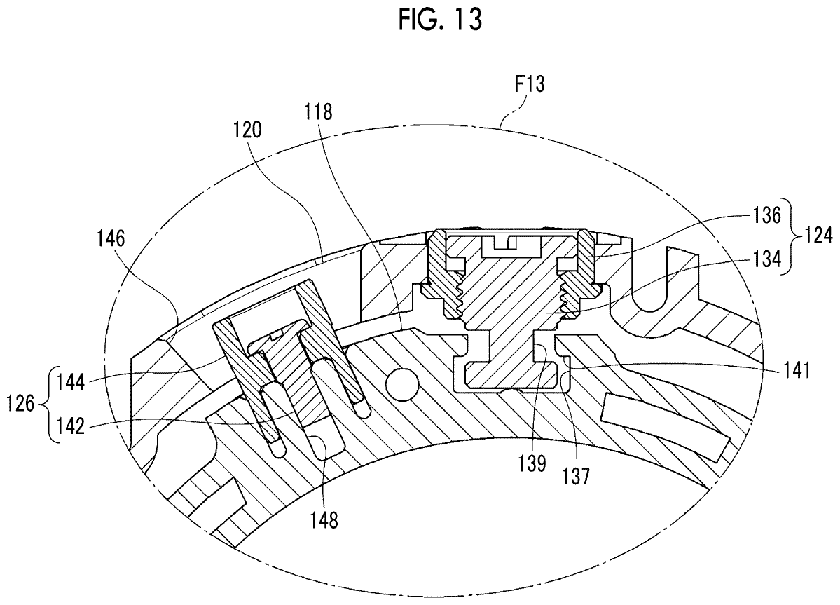

First, in order to clarify the effects of the lens device 14 according to the present embodiment, a comparative example will be described. FIG. 12 shows a cross-sectional view of a lens device 114 according to the comparative example, and FIG. 13 shows an enlarged view of an F13 part of FIG. 12.

The lens device 114 according to the comparative example comprises a holding member 118 and a fixing member 120. The holding member 118 holds a lens (not shown) and is provided inside the fixing member 120.

In addition, the lens device 114 according to the comparative example has two movement members 124, three restricting members 126, one biasing member 128, and one restricting portion 132.

Each movement member 124 is a member that moves the holding member 118 in the direction orthogonal to the optical axis OA with respect to the fixing member 120. Specifically, each movement member 124 has a screw 134 and a nut 136. The nut 136 is fixed to the fixing member 120. The screw 134 is screwed into the nut 136.

A recessed portion 137 that is open to a fixing member 120 side is formed in the holding member 118, and a tip part of the screw 134 is inserted into the recessed portion 137 and is in contact with a bottom of the recessed portion 137. A neck portion 139 is formed in a shaft portion of the screw 134, and an engagement portion 141 that is engaged with the neck portion 139 is formed at an opening portion of the recessed portion 137. In a case where the screw 134 is rotated, the holding member 118 is pushed and pulled by the screw 134, thereby moving the holding member 118 in the direction orthogonal to the optical axis OA with respect to the fixing member 120.

Each restricting member 126 is a member that restricts the position of the holding member 118 in the direction of the optical axis OA with respect to the fixing member 120. Specifically, each restricting member 126 has a screw 142 and a roller 144. A hole 146 that penetrates the fixing member 120 in a radial direction is formed in the fixing member 120, and a screw hole 148 is formed in the holding member 118 at a position corresponding to the hole 146. The screw 142 is inserted into the hole 146 from the outside of the fixing member 120, and a shaft portion of the screw 142 is screwed into the screw hole 148. The screw 142 is fixed to the holding member 118 by screwing the shaft portion into the screw hole 148.

An outer diameter of the roller 144 is set to a dimension smaller than an inner diameter of the hole 146 in the direction of the optical axis OA, and the roller 144 is press-fitted into the hole 146. The roller 144 is a resin member.

A recessed portion 150 that is open to a holding member 118 side is formed in the fixing member 120, and a recessed portion 152 that is open to the fixing member 120 side is formed in the holding member 118. The biasing member 128 is accommodated in a compressed state between a bottom of the recessed portion 150 and a bottom of the recessed portion 152. The holding member 118 is biased toward the optical axis OA side by the biasing member 128.

The restricting portion 132 is a structural portion that restricts the position of the holding member 118 in the direction around the optical axis OA with respect to the fixing member 120. Specifically, the restricting portion 132 has an engagement portion 154 formed in the fixing member 120 and an engagement target portion 156 formed in the holding member 118.

The engagement portion 154 is a protruding portion that protrudes from the fixing member 120 toward the holding member 118 side, and the engagement target portion 156 is a recessed portion that is open to the fixing member 120 side. The engagement portion 154 is inserted into the engagement target portion 156 and is engaged with the engagement target portion 156. The engagement portion 154 is engaged with the engagement target portion 156, whereby the position of the holding member 118 is restricted in the direction around the optical axis OA with respect to the fixing member 120.

However, the lens device 114 according to the comparative example has the following problems. That is, in the lens device 114 according to the comparative example, the nut 136 of the movement member 124 is provided on the fixing member 120. In addition, the engagement portion 141 is formed on the holding member 118, and the engagement portion 141 is engaged with the neck portion 139 formed in the shaft portion of the screw 134. Therefore, the holding member 118 increases in size in the radial direction by the formation of the engagement portion 141, and consequently, the lens device 114 increases in size in the radial direction.

Further, in the lens device 114 according to the comparative example, the roller 144 is press-fitted into the hole 146. Therefore, in a case where the position of the holding member 118 is adjusted by each movement member 124, stick slip (that is, intermittent slip) occurs between an outer peripheral surface of the roller 144 and an inner peripheral surface of the hole 146. As a result, the accuracy of adjusting the position of the holding member 118 decreases in comparison with a case where stick slip is suppressed.

On the other hand, in the lens device 14 according to the present embodiment shown in FIGS. 2 to 11, the nut 36 of the movement member 24 is provided on the holding member 18. Therefore, in comparison with a configuration in which the engagement portion 141 is formed on the holding member 118 as in the lens device 114 according to the comparative example, the holding member 18 can be miniaturized in the radial direction by the elimination of the engagement portion 141, and consequently, the lens device 14 can be miniaturized in the radial direction.

Additionally, the nut 36 is provided on the inner side of the outer contour 18A of the holding member 18. Therefore, the holding member 18 can be miniaturized in the radial direction, for example, in comparison with a configuration in which the nut 36 is provided on the outer side of the outer contour of the holding member 18.

In addition, the roller 44 of the restricting member 26 is loosely inserted into the hole 46 formed in the fixing member 20. Therefore, stick slip occurring between the outer peripheral surface of the roller 44 and the inner peripheral surface of the hole 46 can be suppressed in comparison with a configuration in which the roller 144 is press-fitted into the hole 146 as in the lens device 114 according to the comparative example, so that the accuracy of adjusting the position of the holding member 18 can be improved.

Further, the roller 44 is a metal member. Therefore, for example, the roller 44 can be made thinner in comparison with a case where the roller 44 is a resin member, so that the roller 44 can be miniaturized, and consequently, the lens device 14 can be miniaturized.

Furthermore, the lens device 14 according to the present embodiment exhibits the following specific effects.

That is, in the lens device 14 according to the present embodiment, the first biasing member 28 is disposed within the range of the angle α formed by the movement member 24A and the movement member 24B as viewed from the direction of the optical axis OA. Therefore, one first biasing member 28 can bias the holding member 18 in the movement direction by the movement member 24A and the movement direction by the movement member 24B. As a result, the lens device 14 can be miniaturized, for example, in comparison with a configuration in which separate first biasing members 28 bias the holding member 18 in the movement direction by the movement member 24A and the movement direction by the movement member 24B.

Additionally, the restricting portion 32 is provided along the line connecting the center of the movement member 24A and the optical axis OA as viewed from the direction of the optical axis OA. Therefore, one first biasing member 28 can also bias the engagement portion 54 of the restricting portion 32 in the direction of the X axis with respect to the engagement target portion 56. As a result, the lens device 14 can be miniaturized, for example, in comparison with a configuration in which a biasing member for biasing the engagement portion 54 in the direction of the X axis with respect to the engagement target portion 56 is required separately from the first biasing member 28.

In addition, the first biasing member 28 is disposed on the bisector line L of the angle α as viewed from the direction of the optical axis OA. Therefore, one first biasing member 28 can bias the holding member 18 in the movement direction by the movement member 24A and the movement direction by the movement member 24B in a well-balanced manner, for example, in comparison with a case where the first biasing member 28 is disposed at a position shifted from the bisector line L of the angle α as viewed from the direction of the optical axis OA.

Further, the angle α is a right angle. Therefore, the movement direction of the holding member 18 by the movement member 24A and the movement direction of the holding member 18 by the movement member 24B can be independently defined. As a result, the position of the holding member 18 can be easily adjusted in the direction of the X axis and the direction of the Y axis, in comparison with a case where the angle α is an angle other than the right angle, that is, a case where the movement direction of the holding member 18 by the movement member 24A and the movement direction of the holding member 18 by the movement member 24B are not independent but are interrelated.

Although one embodiment of the technology disclosed in the present application has been described above, the technology disclosed in the present application is not limited to the above description and can be implemented in various modifications within the scope that does not deviate from the gist thereof, in addition to the above description, of course.

What is claimed is:

1. A lens device comprising:
a holding member that holds a lens;
a movement member that moves the holding member in a first direction intersecting an optical axis;
a first biasing member that biases the holding member in a second direction intersecting the optical axis; and
a second biasing member that biases the holding member at least in a direction of the optical axis,
wherein a movement portion of the movement member is provided on the holding member.

2. The lens device according to claim 1,
wherein the movement portion is provided on an inner side of an outer contour of the holding member.

3. The lens device according to claim 1,
wherein the movement member has a screw and a nut, and
the movement portion includes the nut.

4. The lens device according to claim 3, further comprising:
a fixing member,
wherein the screw is rotatably fixed to the fixing member, and
the nut is held by the holding member.

5. The lens device according to claim 1, further comprising:
a restricting member that restricts a position of the holding member in the direction of the optical axis.

6. The lens device according to claim 5,
wherein a plurality of the restricting members are provided, and
the plurality of restricting members are arranged in a direction around the optical axis.

7. The lens device according to claim 5,
wherein the second biasing member is disposed at a position corresponding to the restricting member.

8. The lens device according to claim 5, further comprising:
a fixing member,
wherein the restricting member is loosely inserted into the fixing member.

9. The lens device according to claim 8,
wherein a loose insertion portion of the restricting member is a metal member.

10. The lens device according to claim 9,
wherein the metal member is a shaft member.

11. The lens device according to claim 1,
wherein the movement member includes a first movement member and a second movement member that moves the holding member in a direction different from a movement direction by the first movement member.

12. The lens device according to claim 11,
wherein the first biasing member is disposed within a range of an angle formed by the first movement member and the second movement member, which is less than 180 degrees, as viewed from the direction of the optical axis.

13. The lens device according to claim 12,
wherein the first biasing member is disposed on a bisector line of the angle as viewed from the direction of the optical axis.

14. The lens device according to claim 12,
wherein an angle formed by the first movement member and the first biasing member as viewed from the direction of the optical axis is 30 degrees to 60 degrees.

15. The lens device according to claim 12,
wherein the angle is a right angle.

16. The lens device according to claim 11, further comprising:
a fixing member; and
a restricting portion that restricts a position of the holding member in a direction around the optical axis with respect to the fixing member,
wherein the restricting portion is provided on an opposite side of the optical axis from the first movement member.

17. The lens device according to claim 16,
wherein the restricting portion is provided along a line connecting the first movement member and the optical axis as viewed from the direction of the optical axis.

18. The lens device according to claim 1, further comprising:
a fixing member; and
a restricting portion that restricts a position of the holding member in a direction around the optical axis with respect to the fixing member.

19. The lens device according to claim 18,
wherein the restricting portion has
an engagement portion formed on the fixing member, and
an engagement target portion formed on the holding member and engaged with the engagement portion.

20. The lens device according to claim 19,
wherein the engagement portion has a first protruding portion, and
the engagement target portion has a second protruding portion that is in contact with the first protruding portion.

21. The lens device according to claim 20,
wherein the second protruding portion extends in a direction intersecting a direction in which the first protruding portion extends.
